(19) United States
(12) Patent Application Publication
(10) Pub. No.: US 2025/0209684 A1
(43) Pub. Date: Jun. 26, 2025

(54) IMAGE PROCESSING METHOD FOR VIDEOCONFERENCING, VIDEOCONFERENCING DEVICE

(71) Applicant: SAGEMCOM BROADBAND SAS, BOIS-COLOMBES (FR)

(72) Inventors: Jérôme BERGER, Bois-Colombes (FR); Jad Abdul Rahman OBEID, Bois-Colombes (FR)

(21) Appl. No.: 18/981,193

(22) Filed: Dec. 13, 2024

(30) Foreign Application Priority Data
Dec. 21, 2023 (FR) 2314755

(51) Int. Cl. G06T 11/00; G06T 7/11; G06T 7/194; G06V 20/20; G06V 20/40; G06V 20/52; G06V 40/16

(52) U.S. Cl. CPC G06T 11/00; G06T 7/11; G06T 7/194; G06V 20/20; G06V 20/52; G06V 40/172; G06T 2207/10016; G06T 2207/20032; G06T 2207/20036; G06T 2207/30201; G06T 2210/62; G06V 20/40

(57) ABSTRACT

An image processing method for videoconferencing comprising a step of analyzing a sequence of input images obtained from a camera, the input images being composed of a plurality of pixels, characterized in that the analysis step includes: a comparison, on an image border area, of the pixels of each image of the input image sequence with the same pixels of a reference image, an operation aimed at masking the pixels located in the image border area of the input image when said pixels exhibit, with respect to the same pixels of the reference image, a deviation greater than a first threshold.

### CROSS REFERENCE TO RELATED APPLICATIONS

The present application claims priority to French Application No. 2314755 filed on Dec. 21, 2023 with the Intellectual Property Office of France, the entire disclosure of which is incorporated herein by reference.

### TECHNICAL FIELD

The various embodiments described in the present disclosure relate to a video communication method and device. The method and device can be used, for example, as part of a video calling or videoconferencing application. Such a method can be used in a wide range of apparatuses, such as a TV set-top box, a cell phone or a computer.

### BACKGROUND

Video calling and videoconferencing systems have found numerous applications in both the professional and private spheres, or at the intersection of the professional and private spheres, notably in teleworking. The boundary between the private sphere and the professional environment has thus become permeable. As such, a video call can be considered as an intrusion, because of the information it provides about the physical, family, or professional environment of whoever is on the other end of the call. Various solutions have been proposed, including the possibility of blurring the image background, or superimposing a virtual background. However, such solutions are not suitable for situations where people intrude into the picture plane.

There is a need for an image processing method for videoconferencing that can effectively handle this type of situation.

### SUMMARY

A first aspect of the present disclosure relates to an image processing method for videoconferencing. A sequence of input images is obtained from a camera, the input images being composed of a plurality of pixels and comprising an image border area and a central area. The method comprises a step of analyzing the input image sequence including: comparing, on the image border area excluding the central area, the pixels of each image of the input image sequence with the same pixels of a reference image, the reference image used for the comparison with a current input image being obtained from one or more previous input images of the input image sequence, and an operation aimed at masking the pixels situated in the image border area of the input image when said pixels exhibit, with respect to the same pixels of the reference image, a deviation δ greater than a first threshold σ₁.

For example, the reference image used for comparison with a current input image is obtained by replacing, in the image border area of the previous input image, pixels which exhibit a deviation greater than said first threshold from the same pixels of a previous reference image used for comparison with the previous input image, with the same pixels of the previous reference image. In another example, the reference image is a previous output image obtained by masking the previous input image.

In one embodiment, said operation includes replacing pixels in the image border area of the input image for which the deviation δ is greater than the first threshold σ₁ with the same pixel of a replacement image. For example, said operation involves mixing between the pixel of the image border area of the input image and the same pixel of the replacement image, when the deviation δ is between the first threshold σ₁ and a second threshold σ₂ lower than the first threshold.

In another embodiment, said operation comprises producing a first mask to be applied to a replacement image used to transform the input image into an output image, said first mask assigning a transparency coefficient α to each pixel, the transparency coefficient of the pixels located in the image border area being a function of the deviation δ between the pixel of the input image and that of the reference image, and the transparency coefficient of the pixels located outside the image border area being set so as to obtain maximum opacity. For example, producing the first mask involves a step of obtaining a binary mask whose transparency coefficients have a binary value, and a step of low-pass filtering the binary mask to obtain a non-binary mask whose transparency coefficients α have a non-binary value. For example, the transparency coefficients in the image border area are set so as to obtain: maximum transparency when the deviation δ is greater than said first threshold σ₁, maximum opacity when the deviation δ is less than a second threshold σ₂, and partial transparency when the deviation δ is between said first and second thresholds σ₁ and σ₂. For example, when the deviation δ is between said first and second thresholds σ₁ and σ₂, the transparency coefficient α is a function of the ratio of the difference between the deviation δ and the second threshold σ₂ to the difference between the first threshold σ₁ and the second threshold σ₂.

In one embodiment, the production of the first mask further comprises a step of mask filtering by a morphological filter, for example a filter applying a small opening to suppress isolated pixels, followed by expansion to ensure that the mask covers the objects to be masked. And/or the production of the first mask includes a step of filtering the mask with a median filter to reduce noise.

In one embodiment, the image processing method further comprises a step of detecting, in the input images, unauthorized persons in a field of view of the videoconference. In one embodiment, the image processing method then includes a step of producing a second mask to be applied to the replacement image, said second mask assigning a maximum transparency coefficient to the pixels corresponding to the unauthorized persons. When the analysis step produces a first mask, this is combined with the second mask to obtain a third mask, which is applied to the replacement image to obtain the output image.

In one embodiment, detection of an unauthorized person triggers replacement of the output image by a still image.

In one embodiment, the operation that produces the first mask comprises region filtering to modify the first mask in order to make visible objects in the input image that have at least one of the following characteristics: object of large size and/or object that extends outside the image border area and/or object that does not touch the edge of the image.

A second aspect of the present disclosure relates to a videoconferencing device comprising means for performing the image processing method as described above. The videoconferencing device can be constituted by software means, that is, instructions intended to be executed by a set of circuits to perform one or more or all of the steps to be carried out by the device in application of an image processing method as described in the present disclosure. The circuit assembly may consist of dedicated circuitry. Alternatively, it may be consist of one or more processors and one or more memories comprising one or more computer program codes, said processors, memories and computer codes being configured to cause the device to execute one or several or all of the steps of the methods described in the present disclosure. Thus, in one embodiment, the device comprises at least one processor and at least one non-volatile memory which contains computer program instructions which, when executed by said at least one processor, cause execution of an image processing method as described above. For example, said device is a TV set-top box, or a cell phone, or a computer.

A third aspect of the present disclosure relates to a computer program product comprising instructions which, when executed by at least one processor, cause said at least one processor to execute an image processing method as described above. For example, the computer program product can be downloaded by a computer or cell phone user to carry out a videoconference.

A fourth aspect of the present disclosure relates to a non-volatile storage medium comprising instructions which, when executed by at least one processor, cause said at least one processor to execute an image processing method as described above.

### BRIEF DESCRIPTION OF THE FIGURES

The embodiments will be better understood in light of the following detailed description and the accompanying drawings, which are given by way of illustration only and therefore do not limit the present disclosure.

FIG. 1 is a schematic diagram of an example videoconferencing system showing one or more embodiments.

FIG. 2 is a schematic representation of an image 20 corresponding to a field of view 201 visible in a videoconferencing session.

FIG. 3 is a flowchart of a method according to one or more exemplary embodiments.

FIG. 4 is a flowchart detailing an example embodiment of how to perform an analysis step in the image processing method described in view of FIG. 3.

FIG. 5 is a flowchart of an example embodiment of the implementation of an image processing method as described here, with detection of unauthorized persons.

FIG. 6 is a flowchart detailing an example of region filtering that can be used in one embodiment of the image processing method as described in view of FIG. 5.

FIGS. 7A and 7B are flowcharts corresponding to two alternative embodiments wherein the processing relating to the image border area is decoupled from the processing relating to the detection of unauthorized persons.

### DETAILED DESCRIPTION

Various embodiments will now be described in more detail, non-limitingly, with reference to the drawings accompanying the present disclosure and showing certain exemplary embodiments.

The specific structural and functional details disclosed here are non-limiting examples. The embodiments disclosed here may undergo various modifications and alternative forms. The subject matter of the disclosure may be embodied in many different forms and should not be construed as being limited solely to the embodiments presented herein as illustrative examples. It should be understood that there is no intention to limit the embodiments to the particular forms described in the remainder of this document.

In the following description, identical, similar or analogous elements will be referred to by the same reference numbers. The block diagrams, flowcharts and message sequence diagrams in the figures shows the architecture, functionalities and operation of systems, apparatuses, methods and computer program products according to one or more exemplary embodiments. Each block of a block diagram or each step of a flowchart may represent a module or a portion of software code comprising instructions for implementing one or more functions. According to certain implementations, the order of the blocks or the steps may be changed, or else the corresponding functions may be implemented in parallel. The method blocks or steps may be implemented using circuits, software or a combination of circuits and software, in a centralized or distributed manner, for all or part of the blocks or steps. The described systems, devices, processes and methods may be modified or subjected to additions and/or deletions while remaining within the scope of the present disclosure. For example, the components of a device or system may be integrated or separated. Likewise, the features disclosed may be implemented using more or fewer components or steps, or even with other components or by means of other steps. Any suitable data-processing system can be used for the implementation. An appropriate data-processing system or device comprises for example a combination of software code and circuits, such as a processor, controller or other circuit suitable for executing the software code. When the software code is executed, the processor or controller prompts the system or apparatus to implement all or part of the functionalities of the blocks and/or steps of the processes or methods according to the exemplary embodiments. The software code can be stored in non-volatile memory or on a non-volatile storage medium (USB key, memory card or other medium) that can be read directly or via a suitable interface by the processor or controller.

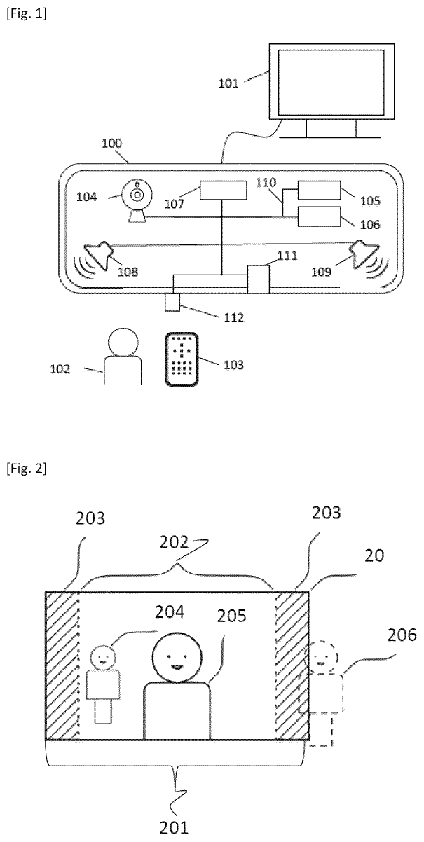

FIG. 1 is a schematic diagram of a system showing one or more non-limiting embodiments. The system shown in FIG. 1 comprises a device 100 and a display screen 101. The device 100 comprises a processor 105, a non-volatile memory 106 comprising software code, and a working memory 107. The various components of the device 100 are controlled by the processor 105, for example via an internal bus 110.

The device 100 further comprises an interface (not shown) through which it is connected to the screen 101. This interface is, for example, an HDMI interface. The device 100 is adapted to generate a video signal for display on the screen 101. The video signal is generated, for example, by the processor 105. The device 100 further comprises an interface 111 for connection to a communications network, such as the Internet.

The device 100 further comprises a camera 104 and a microphone 112. The software code comprise a video communication application (video calling, videoconferencing, etc.) using the camera and microphone.

The device 100 can optionally be controlled by a user 102, for example, using a user interface, shown here in the form of a remote control 103. The device 100 may optionally comprise an audio source, shown as two speakers 108 and 109. The device may optionally comprise a neural processing unit (NPU), whose function is to accelerate the calculations required for a neural network.

In some contexts, the device 100 is, for example, a digital TV receiver/set-top box, while the display screen is a TV set.

In particular, the non-volatile memory 106 comprises computer program instructions which, when executed by the processor 105, cause the image processing method subject to the present disclosure to be implemented.

The system shown in FIG. 1 is for illustrative purposes only. Practical implementations can include more or fewer components. In addition, certain components described as being integrated into the device 100 may be external to the device and connected to it via a suitable interface—this is particularly the case for the camera 104 or microphone 112. On the other hand, certain system components described as external to the device 100 can be integrated into the device—for example, the display screen or the user interface 103.

FIG. 2 is a schematic representation of an image 20 corresponding to a field of view 201 visible in a videoconferencing session. This image has a central area 202 and an image border area 203, consisting in this example of two strips located to the right and left of the frame 201. For example, the strips in the image border area each represent 10% of the size of the image 20. Alternatively, the border area can also include two strips at the top and bottom, not shown in the figure, in addition to the two strips on the right and left. In the example shown in FIG. 2, two people 204 and 205 are located in the central area 202, and a person 206 enters the field of view 201 from the right. The person 206 is therefore partially visible in the right strip of the image border area 203.

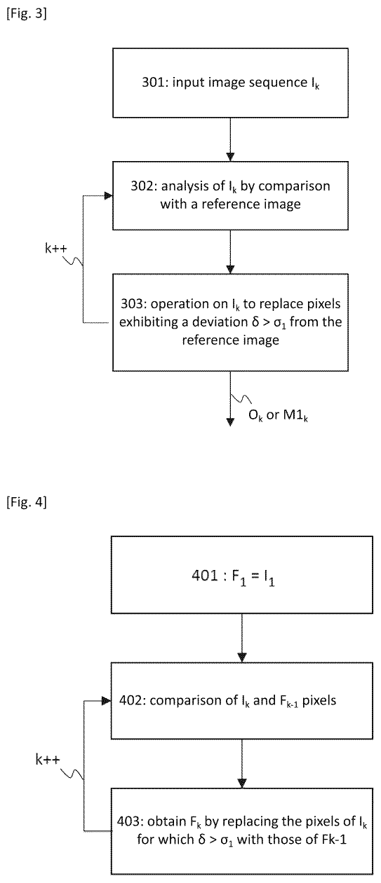

FIG. 3 is a flowchart of a method according to one or more exemplary embodiments. In 301, a sequence of input images is obtained, either directly from the camera 104, or indirectly after processing has been performed on the images captured by the camera 104. In 302, each input image in the input image sequence is analyzed to identify incoming objects visible at the border of the image. These objects may be people or other elements that enter the field of view 201. The analysis performed in 302 comprises a comparison, on the image border area 203, of the pixels of each image of the input image sequence with the same pixels of a reference image obtained from one or more previous input images of the input image sequence. An operation is then carried out, in 303, which aims to mask the pixels located in the image border area of the input image when said pixels present, compared to the same pixels of the reference image, a deviation δ greater than a first threshold σ₁. Several ways of performing this operation will be described below. Depending on the embodiment considered, the result of the operation performed in 303 is either an output image wherein pixels located at the image border for which the deviation δ was greater than the first threshold σ₁ have been masked, or a mask intended to be used to transform the input image in order to mask said pixels. In both cases, the end result is an output image wherein the incoming objects, visible at least partially in the image border area, are masked out.

In other words, the comparison in step 302 is performed on the image border area, excluding the central area.

Conventionally, pixels can be compared by evaluating a difference between all or part of the set of values of two pixels at the same position. For example, and without limitation, a conventional method for comparing pixels is to calculate a Euclidean distance in the space defined by the sets under consideration (e.g. luminance, or color channels, or both). The resulting deviation can then be compared with a threshold.

In this way, the method described enables objects entering the field of view 201 to be masked from the first image in which these objects begin to appear, even when the object is only partially in the field of view 201 (truncated object) and therefore cannot be detected by object detection means. For example, the method described masks the pixels corresponding to the person 206 in the image border 203.

FIG. 4 shows an example of the analysis step 302. In 401, the first image I₁ of the input image sequence is stored as the first reference image F₁. Then, in 402, for each image Iₖ (k>1) of the input image sequence, the comparison is made between the pixels of the image border area 203 of the input image Iₖ, and the same pixels in the reference image Fₖ₋₁. In 403, a subsequent reference image Fₖ is obtained. This subsequent reference image Fₖ is intended for comparison with the subsequent input image Iₖ₊₁ of the input image sequence. It is obtained by replacing, in the image border area 203 of the input image Iₖ, pixels with a deviation δ greater than said first threshold σ₁ from the same pixels of the reference image Fₖ₋₁, with the same pixels of the reference image Fₖ₋₁. Analysis then resumes in 402 with the next input image Iₖ₊₁ and the next reference image Fₖ.

The operation described in 303 can be performed between steps 402 and 403, or in parallel with step 403, or following step 403. Alternatively, the operation described in 402 and 403 may not be performed, and the previous output image Oₖ₋₁ may be used as the current reference image Fₖ.

In a first embodiment, the operation performed in 303 includes replacing pixels in the image border area of the input image for which the deviation δ is greater than the first threshold σ₁ with the same pixel of a replacement image Rₖ. For example, the replacement image Rₖ can be the current reference image Fₖ₋₁ or a still image. Optionally, the operation performed in 303 comprises, in addition to this replacement, a blending between the pixel of the image border area of the input image Iₖ and the same pixel of the replacement image Rₖ, when the deviation δ is between the first threshold σ₁ and a second threshold σ₂ lower than the first threshold. For example, the operation carried out in 303 delivers an output image Ok from the input image Iₖ and the replacement image Rₖ with Oₖ=αRₖ+(1−α)Iₖ.

The term α is a transparency coefficient: the higher it is, the greater the transparency applied to the replacement image Rₖ. When α=0, maximum opacity is applied to the replacement image Rₖ, that is, the pixel in the output image Oₖ is identical to the pixel in the input image Iₖ. When α=1, maximum transparency is applied to the replacement image Rₖ, that is, the pixel of the input image Iₖ is replaced by the pixel of the replacement image Rₖ in the output image Oₖ. And when 0<α<1, a blend is produced between the pixel of the input image Iₖ and that of the replacement image Rₖ.

In a second embodiment, the operation carried out in 303 involves producing a first mask. The first mask M1ₖ is created by assigning a transparency coefficient α to each pixel of said mask. The transparency coefficient of the pixels located in the central area 202 is set to obtain maximum opacity. The transparency coefficient of the pixels located in the image border area 203 is a function of the distance o between the pixel of the input image Iₖ and that of the reference image Fₖ₋₁.

In a first example embodiment of the first mask M1ₖ, pixels whose deviation is greater than the first threshold σ1 are assigned a value of 1 (maximum mask transparency) and pixels whose deviation is less than or equal to the first threshold σ1 are assigned a value of 0 (maximum mask opacity). The resulting mask pixels have a binary value (0 or 1). Optionally, low-pass filtering is applied to the binary mask to obtain a first non-binary mask M1ₖ.

Optionally, a morphological filter is also applied, for example a filter applying a small aperture (radius 1 or 2, for example) to remove isolated pixels, followed by a dilation (radius 2 to 10, for example) to ensure that the mask covers the objects to be masked. Optionally, a median filter is applied, alone or in combination with the morphological filter, to reduce noise.

In a second example embodiment, the first mask M1ₖ is obtained by directly assigning non-binary values to the mask pixels. Thus, pixels for which the deviation is greater than the first threshold σ₁ are assigned a value 1 (maximum mask transparency); pixels for which the deviation is less than the second threshold σ₂ are assigned a value 0 (maximum mask opacity), and pixels for which the deviation δ is between said first and second thresholds σ₁ and σ₂ are assigned a transparency coefficient α, with for example

$$α = \frac{δ - {σ}_{2}}{{σ}_{1} - {σ}_{2}}$$

(partial transparency). Optionally, a morphological and/or median filter as described above can also be applied to the resulting non-binary mask. This embodiment is particularly well suited to cases where the replacement image is derived from the reference image.

Advantageously, the image processing method comprises, in addition to analysis 302 and operation 303, a detection in the input images of unauthorized persons in a field of view of the videoconference, that is, persons to be masked (authorized persons not having to be masked). This detection can take place in parallel with or following the analysis 302 and operation 303. This can be achieved, for example, by using a database of authorized and/or unauthorized persons, which includes a descriptive vector for each person, such as a vector describing the person's face. In the input image Iₖ, faces can be detected and a vector representation extracted, for example using a neural network solution. This vector representation can then be compared with the contents of the database to determine whether or not the person is authorized. Once detected, unauthorized persons can be masked.

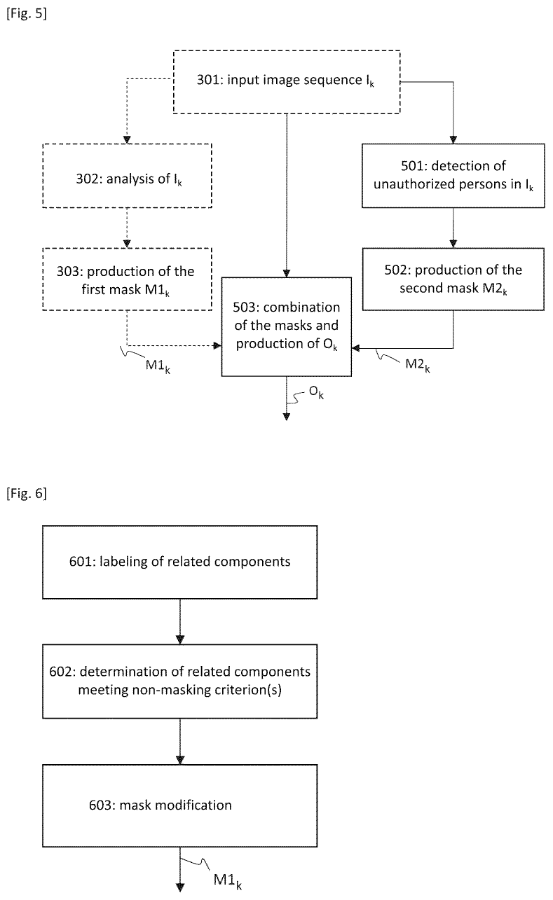

In the embodiment of Figure FIG. 5, in 501, unauthorized persons are detected in the image Iₖ. In this example, detection is performed in parallel with analysis 302 and operation 303. The operation 303 produces a first mask M1ₖ as described above. In 502, a second mask M2ₖ is produced from the detection result, by assigning a maximum transparency coefficient to the pixels corresponding to the unauthorized persons. In 503, the first and second masks are combined and the result of this combination is applied to the replacement image Rₖ, which is used to transform the input image Iₖ into an output image Oₖ. The output image Oₖ is ready for transmission to one or more recipients. The transmission may be preceded by further processing of the image and/or previous and subsequent images, such as compression, adding elements to the image, etc.

For example, combining the first and second masks M1ₖ and M2ₖ produces a third mask M3ₖ. If the first and second masks are binary, the third mask is transparent where at least the first or second mask is transparent, and opaque where the first and second masks are opaque. In the case where the first and second masks are non-binary, the third mask is, for example, the maximum of the first and second masks, or in another example, M3ₖ=1−(1−M1ₖ)*(1−M2ₖ).

In this embodiment, it is possible for unauthorized persons to appear in the image border area and be detected in detection step 501. These people will be removed by applying the second mask M2ₖ. It is therefore redundant to also process them through the first mask M1ₖ. Processing via the first mask M1ₖ would also run the risk of introducing artifacts (e.g. an object masked in the image border area 203 but visible in the central area 202 because this object is not an unauthorized person). Advantageously, the operation 303 includes filtering, known as region filtering, which modifies the first mask M1ₖ to avoid masking certain objects in the image border area 203. For example, region filtering makes large objects and/or objects that extend into the central area 202 and/or objects that do not touch the edge of the input image visible.

Region filtering is described in more detail with respect to FIG. 6. In 601, the region filtering applies a related component labeling of the first mask according to a procedure known in the literature, for example from “Image analysis: filtering and segmentation” J.-P. Cocquerez and S. Philipp, ed. Masson (1995) pages 61-63. This step identifies related components, each corresponding to an object, and assigns to each pixel of the first mask an identifier of the related component to which the pixel belongs. In 602, the region filtering identifies related components that should not be masked according to at least one of the following criteria: if the number of pixels assigned to the related component is greater than a fixed threshold (e.g. 200 pixels), if the size of a bounding box of the related component is greater than a fixed threshold (e.g. if the width and height are both greater than 32), if the related component does not touch the edge of the image, if the related component touches the central area 202 of the image. Then, in 603, the region filtering assigns the value 0 (opaque) to the pixels of the related components identified in step 602 to produce the first mask M1ₖ, which is then combined with the second mask M2ₖ.

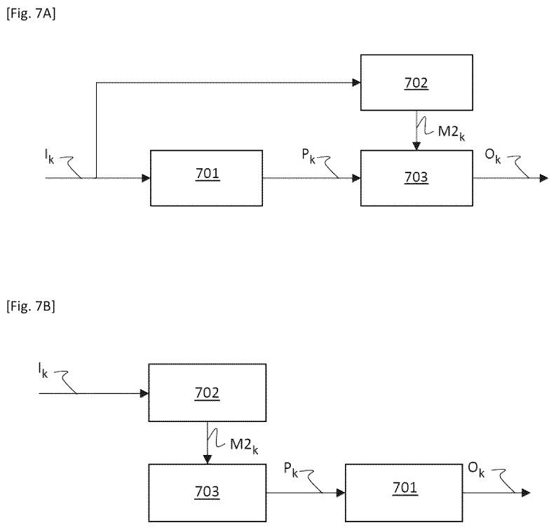

Figures FIG. 7A and FIG. 7B depict two alternative embodiments wherein the processing relating to the image border area is decoupled from the processing relating to the detection of unauthorized persons. In the first alternative, described in FIG. 7A, processing for the image border area (represented by block 701) is carried out upstream of processing for detecting unauthorized persons (represented by block 702). In this case, the input image Iₖ is modified in 701 to produce an intermediate image Pk. This intermediate image Pₖ is then modified a second time in 703 from the replacement image Rₖ, to which the second mask M2ₖ obtained in 702 is applied. The output image Oₖ is then obtained. In the second alternative, described in FIG. 7B, processing for the image border area (represented by block 701) is carried out downstream of processing for detecting unauthorized persons (represented by block 702). In this case, the second mask M2ₖ is obtained in 702 from the input image Iₖ. In 703, an intermediate image Pₖ is obtained from the replacement image Rₖ, to which the mask M2ₖ obtained in 702 is applied. The intermediate image Pₖ is then applied to the block 701, which performs image border processing and delivers the output image Oₖ. In these two example embodiments, a first mask M1ₖ can be used for image border processing. But this is not necessary: images can be edited directly.

In another embodiment, when an unauthorized person is detected, the camera is switched off, or a still image is displayed. In this case, image border processing is advantageously interrupted and only resumed when no unauthorized person is in the videoconferencing field of view.

The person skilled in the art will understand that all the block diagrams presented here represent conceptual views, given by way of example, of circuits incorporating the principles of the disclosure.

Each function, block, and step described can be implemented in hardware, software, firmware, middleware, microcode or any suitable combination thereof. If implemented in software, the functions or blocks of the block diagrams and flowcharts can be implemented by computer program instructions/software codes, which can be stored or transmitted on a computer-readable medium, or loaded onto a general-purpose computer, special-purpose computer or other programmable processing device and/or system, so that the computer program instructions or software code running on the computer or other programmable processing device create the means for implementing the functions described in this description.

Although aspects of this disclosure have been described with reference to specific achievements, it should be understood that these achievements merely illustrate the principles and applications of this disclosure. It is therefore understood that numerous modifications can be made to the illustrative embodiments and that other arrangements can be devised without departing from the spirit and scope of the disclosure as determined on the basis of the claims and their equivalents.

Advantages and solutions to problems have been described above with regard to specific embodiments of the invention. However, advantages, benefits, solutions to problems, and any element which may cause or result in such advantages, benefits or solutions, or cause such advantages, benefits or solutions to become more pronounced shall not be construed as a critical, required, or essential feature or element of any or all of the claims.

1. An image processing method for videoconferencing comprising a step of analyzing a sequence of input images obtained from a camera, the input images being composed of a plurality of pixels and comprising an image border area and a central area, characterized in that the analysis step includes:
a comparison, on the image border area excluding the central area, of the pixels of each image of the input image sequence with the same pixels of a reference image, the reference image used for the comparison with a current input image being obtained from one or more previous input images of the input image sequence, and
an operation aimed at masking the pixels located in the image border area of the input image when said pixels exhibit, with respect to the same pixels of the reference image, a deviation δ greater than a first threshold σ₁.

2. The method according to claim 1, wherein the reference image used for comparison with a current input image is obtained by replacing, in the image border area of the previous input image, pixels which exhibit a deviation greater than said first threshold from the same pixels of a previous reference image used for comparison with the previous input image, with the same pixels of the previous reference image.

3. The method according to claim 1, wherein said operation includes replacing pixels in the image border area of the input image for which the deviation δ is greater than the first threshold σ₁ with the same pixel of a replacement image.

4. The method according to claim 3, wherein said operation comprises a blending between the pixel of the image border area of the input image and the same pixel of the replacement image, when the deviation δ is between the first threshold σ₁ and a second threshold σ₂ lower than the first threshold.

5. The method according to claim 1, wherein said operation comprises producing a first mask to be applied to a replacement image used to transform the input image into an output image, said first mask assigning a transparency coefficient α to each pixel, the transparency coefficient of the pixels located in the image border area being a function of the deviation δ between the pixel of the input image and that of the reference image, and the transparency coefficient of the pixels located outside the image border area being set so as to obtain maximum opacity.

6. The method according to claim 5, wherein producing the first mask involves a step of obtaining a binary mask whose transparency coefficients have a binary value, and a step of low-pass filtering the binary mask to obtain a non-binary mask whose transparency coefficients α have a non-binary value.

7. The method according to claim 5, wherein the transparency coefficients in the image border area are set so as to obtain: maximum transparency when the deviation δ is greater than said first threshold σ₁, maximum opacity when the deviation δ is less than a second threshold σ₂, and partial transparency when the deviation δ is between said first and second thresholds σ₁ and σ₂.

8. The method according to claim 7, wherein when the deviation δ is between said first and second thresholds σ₁ and σ₂, the transparency coefficient α is a function of the ratio of the difference between the deviation δ and the second threshold σ₂ and the difference between the first threshold σ₁ and the second threshold σ₂.

9. The method according to claim 5, wherein the production of the first mask comprises a mask filtering step using a morphological filter and/or a median filter.

10. The method according to claim 5, wherein the method comprises a step of detecting, in the input images, unauthorized persons in a field of view of the videoconference.

11. The method according to claim 10, wherein the method includes a step of producing a second mask to be applied to the replacement image, said second mask assigning a maximum transparency coefficient to the pixels corresponding to the unauthorized persons.

12. The method according to claim 11, wherein the second mask is combined with the first mask to obtain the output image.

13. The method according to claim 10, wherein detection of an unauthorized person triggers replacement of the output image by a still image.

14. The method according to claim 10, wherein said operation includes region filtering to modify the first mask in order to make visible objects in the input image that have at least one of the following characteristics: object of large size and/or object that extends outside the image border area and/or object that does not touch the edge of the image.

15. A videoconferencing device comprising means for executing the image processing method according to claim 1.

16. A TV set-top box comprising a device according to claim 15.

17. A computer program product comprising instructions which, when executed by at least one processor, cause the image processing method of claim 1 to be executed by said at least one processor.

18. A non-transitory storage medium comprising instructions which, when executed by at least one processor, cause said at least one processor to execute the image processing method of claim 1.
